(19) United States
(12) Patent Application Publication
(10) Pub. No.: US 2023/0323553 A1
(43) Pub. Date: Oct. 12, 2023

(54) PULSED ELECTRODEPOSITION FOR REVERSIBLE METAL ELECTRODEPOSITION TO CONTROL METAL FILM MORPHOLOGY AND OPTICAL PROPERTIES

(71) Applicant: The Regents of the University of Colorado, a Body Corporate, Denver, CO (US)

(72) Inventors: Andrew L. Yeang, Boulder, CO (US); Sarah Grunsfeld, Denver, CO (US); Yuchun Cai, Boulder, CO (US); Michael McGehee, Boulder, CO (US)

(21) Appl. No.: 18/298,967

(22) Filed: Apr. 11, 2023

Related U.S. Application Data
(60) Provisional application No. 63/330,140, filed on Apr. 12, 2022.
(60) Provisional application No. 63/432,534, filed on Dec. 14, 2022.

(51) Int. Cl. C25D 1/00; C25D 17/10

(52) U.S. Cl. CPC C25D 1/00; C25D 17/10

(57) ABSTRACT

Disclosed are methods and systems of reversible metal electrodeposition (RME) devices with applications in dynamic smart windows. Embodiments use a RME device that includes two transparent substrates that sandwich a working electrode, counter electrode, and an electrolyte solution. Embodiments apply a pulsed voltage to the RME device that causes electrochemical deposition of metal ions from the electrolyte solution to create a metallic film on the working electrode. The metallic film results in reduced light transmittance of the RME device.

### CROSS-REFERENCE TO RELATED APPLICATIONS

This application claims priority to and the benefit of U.S. Provisional Patent Application Ser. No. 63/330,140 entitled PULSED ELECTRODEPOSITION FOR REVERSIBLE METAL ELECTRODEPOSITION TO CONTROL METAL FILM MORPHOLOGY AND OPTICAL PROPERTIES filed Apr. 12, 2022 and U.S. Provisional Patent Application Ser. No. 63/432,534 entitled PULSED ELECTRODEPOSITION FOR REVERSIBLE METAL ELECTRODEPOSITION TO CONTROL METAL FILM MORPHOLOGY AND OPTICAL PROPERTIES filed Dec. 14, 2022. Each of the foregoing applications is incorporated herein by reference in its entirety.

### STATEMENT REGARDING FEDERALLY SPONSORED RESEARCH

This invention was made with government support under grant no. 2127308 awarded by the National Science Foundation. The government has certain rights in the invention.

### BACKGROUND

Combatting climate change has gained significant global awareness resulting in a number of measures to reduce greenhouse gas emissions and even achieve net-zero carbon emissions. Currently buildings use large amounts of electricity through air conditioning, heating, and lighting. Additionally, significant energy is wasted due to heat loss and heat gain from windows.

For example, a building design may contain large windows to improve the aesthetics of the building, allow for outdoor viewing while indoors, and to provide natural light which reduces the need for indoor lighting. However, during cool periods, heat is lost from inside the building which requires heating the building and during warm periods, the poorly insulated glass causes overheating. When a building is overheated, either an air conditioning system is required or windows can be blocked with blinds or curtains. However, when the windows are blocked, natural light is reduced and indoor lighting is required.

Dynamic smart windows have been developed to variably adjust the color or opacity of the window through external stimuli to reduce heat loss and heat gain from windows. One smart window utilizes thermochromic based technologies which changes light transmittance based on temperature. For example, in cool temperatures, a cross-linked hydrophilic polymer chain will bond with surrounding water through hydrogen bonds resulting in high transmittance. In warmer temperatures, the hydrogen bonds are broken which scatters light and reduces the transmittance. While thermochromic materials are able to change transmittance, the materials lack user-control making the materials more appropriate for thermal radiation mitigation in spacecraft.

Another option is using photochromic devices which are adaptive based on light-based stimuli. For example, the material responds to incident solar radiation. When there is increased radiation, the window darkens and when there is decreased radiation, the window lightens. Photochromic devices work well in auto-dimming transition glasses, however, show problems when used in larger windows. More specifically, photochromic devices are activated by UV light. Therefore, if used in a window, the window would only dim when in direct sunlight and would not be able to dim in the case where the window is facing away from direct sunlight. Also, similarly to thermochromic based technologies, photochromic devices lack user-control.

Additionally, electrochromic devices are adaptive based on external electric potential. When a voltage is applied to these materials, ions from an electrode are attracted to a network within the semi-conductive structure. Ions can be inserted or extracted resulting in a reversible optical change. While some manufactures have been able to commercialize inorganic electrochromic smart windows (e.g., SageGlass, View, Inc. and Halio, Inc.), the uniform and scalable deposition is slow, expensive, and susceptible to defects that can cause shunting in the window. Also, the windows have poor color neutrality due to the materials commonly having a dark blue color. Even as some of these companies have improved the windows to reduce the previously mentioned issues, the price of these smart windows can be anywhere from $50 to $200 per square foot. Therefore, only commercial buildings in high income areas can afford such smart windows.

Accordingly, there is an on-going need for smart windows that are composed of materials that are UV stable, processable, and affordable. Additionally, smart windows should be able to last for a number of years and be durable. Lastly, the smart windows need to cover entire walls of buildings with tint uniformity, able to control heat flow while maintaining transparency, and allow user-control.

### SUMMARY

Disclosed embodiments relate to reversible metal electrodeposition materials with applications in dynamic smart windows. Embodiments simultaneously achieve high durability, color neutrality, low haze, fast switching speeds, and low-cost manufacturing. Additionally, the disclosed embodiments exhibit high contrast without the need for additional power to hold the material at a given optical state.

An exemplary method includes providing a reversible metal electrodeposition (RME) device that includes two transparent substrates, wherein each transparent substrate is on an outside of the device (e.g., a window), a working electrode located near one of the two transparent substrates, a counter electrode located near another of the two transparent substrates, an electrolyte solution located between the working electrode and the counter electrode. The method involves applying a pulsed voltage to the RME device, wherein the pulsed voltage includes an on phase and an off phase, so as to cause electrochemical deposition of metal ions from the electrolyte solution, creating a metallic film on the working electrode, reducing light transmittance, by the metallic film, through the RME device.

An exemplary reversible metal electrodeposition (RME) device includes two transparent substrates, wherein each transparent substrate is on an outside of the device, a working electrode located near one of the two transparent substrates, a counter electrode located near another of the two transparent substrates, and an electrolyte solution located between the working electrode and the counter electrode. A power source is also provided, which delivers a pulsed voltage to the working electrode and/or the counter electrode. During operation the RME device reversibly changes light transmittance through the device when the pulsed voltage is applied to the RME device which causes electrochemical deposition of metal ions from the electrolyte solution to create a metallic film on the working electrode.

In an embodiment the electrolyte solution includes water and at least one of Cu(ClO₄), BiOClO₄, HClO₄, or LiClO₄.

In an embodiment the working electrode is a transparent conducting oxide (TCO) working electrode.

In an embodiment the working electrode is a Pt modified ITO working electrode.

In an embodiment the metal ions include Cu and Bi.

In an embodiment the pulsed voltage has a duty cycle of about 5%, or about 10%, or about 15%, or about 20%, or about 25%, or about 50%, or about 60%, or from about 5% to about 60%, or any other range between two such values.

In an embodiment the pulsed voltage has a frequency of about 0.1 Hz, or about 0.5 Hz, or about 1 Hz, or about 5 Hz, or about 10 Hz, or about 15 Hz, or about 20 Hz, or from about 0.1 Hz to about 20 Hz, or any other range between two such values.

In an embodiment the reducing light transmittance (i.e., window tinting) results in about 0.1% transmittance, or about 1% transmittance, or about 5% transmittance, or about 10% transmittance, or about 15% transmittance or from about 0.1% transmittance to about 15% transmittance, or any other range between two such values.

In an embodiment the pulsed voltage is applied for about 0.1 second, or about 1 second, or about 10 seconds, or about 20 seconds, or about 30 seconds, or about 60 seconds, or about 120 seconds, or from about 0.1 second to about 120 seconds, or any other range between two such values.

In an embodiment the RME device is color neutral, with a chroma value of less than 10.

In an embodiment the user controls an amount of light transmittance reduction that is achieved.

In an embodiment the reduced light transmittance is reversible.

In an embodiment the the RME device is a window.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates an example embodiment incorporated into a dynamic smart window.

FIG. 2 illustrates an example RME device.

FIGS. 3A through 3C illustrate experimental electrochemical results of example embodiments.

FIGS. 4A through 4C illustrate experimental optical results of example embodiments.

FIGS. 5A through 5C illustrate experimental reflectance results of example embodiments.

FIG. 6 illustrates SEM images of example embodiments.

FIGS. 7A through 7C illustrate experimental spectro-electrochemical results of example embodiments compared to conventional plating techniques.

FIG. 8 illustrates SEM images of example embodiments compared to conventional plating techniques.

FIG. 9 illustrates the RMS roughness of example embodiments compared to conventional plating techniques.

FIGS. 10A and 10B illustrate experimental reflectance results of example embodiments compared to conventional plating techniques.

### DETAILED DESCRIPTION

Disclosed embodiments relate to reversible metal electrodeposition materials with applications in dynamic smart windows using pulsed voltage electrodeposition. Embodiments simultaneously achieve high durability, color neutrality, low haze, fast switching speeds, and low-cost manufacturing. Additionally, the disclosed embodiments exhibit high contrast without the need for additional power to hold the material at a given optical state.

Disclosed embodiments are able to tint the window material to a 0.1% transmittance state faster initially than conventional plating methods. Additionally, disclosed embodiments reduce dendrite films in the material making disclosed embodiments more effective at blocking light. Also, disclosed embodiments result in compact, uniform, and smooth films that are more reflective and efficient at blocking light.

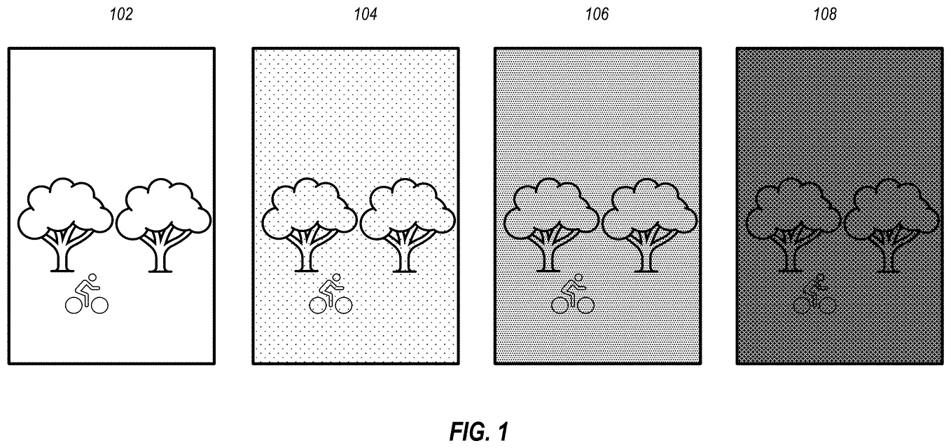

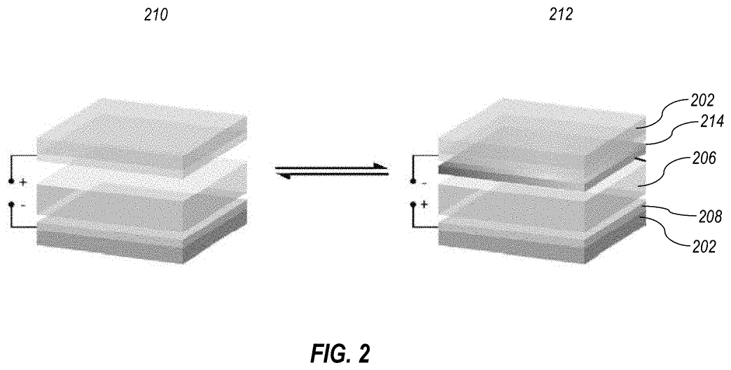

FIG. 1 illustrates an example of disclosed embodiments implemented into dynamic smart windows. As shown in FIG. 1, the transparency of the dynamic smart window may adaptively change between clear 102, light 104, mid 106, and full opacity or full tint 108 where clear 102 allows substantially all natural light to come through the window and full opacity or full tint 108 blocks a significant portion of the natural light, e.g., with as little as 0.1% transmittance. The dynamic smart window is made from a reversible metal electrodeposition (RME) device, shown in greater detail in FIG. 2.

The dynamic smart window may be automatically controlled by stimuli or by a user to conform to the needs and preferences of the user. In some embodiments, the dynamic smart windows may be programmed to change based on day of the week and time of day. For example, in the case of an office building, the dynamic smart window may be in a full state 108 during the weekend when no employees are on site and may be in a clear state 102 when most employees arrive at work during the week.

FIG. 2 illustrates an example reversible metal electrodeposition (RME) device 200. The RME device 200 includes a working electrode 204, electrolyte solution 206, and a counter electrode 208 which may all be sandwiched between two transparent substrates 202. In the dissolution phase 210, metal ions are suspended in the electrolyte solution 206 while the working electrode has a positive charge and the counter electrode has a negative charge. A voltage may be applied to switch the RME device into a deposition phase 212 where the working electrode has a negative charge and the counter electrode has a positive charge. During the deposition phase 212, metal ions found in the electrolyte solution 206 create a metal film 214. The metal film 214 reduces the transmittance of the RME and creates a tinted state.

In more detail, during the deposition phase 212, the metal ions in the electrolyte solution 206 are reduced due to the applied voltage creating the metal film 214 on the working electrode 204 causing the RME device to become opaque. In the dissolution phase 210, the metal ions in the metal film 214 are oxidized and dissolved back into the electrolyte solution 206 therefore removing the metal film 214 and causing the RME device to become transparent.

In some embodiments, the electrolyte solution 206 includes water, and one or more of Cu(ClO₄), BiOClO₄, HClO₄, and/or LiClO₄. In some embodiments, the working electrode 204 is an indium tin oxide (ITO) on a glass substrate which is modified to include platinum nano-particles to create a Pt modified ITO working electrode. In some embodiments, the metal ions that create the metal film 214 are copper (Cu) and/or bismuth (Bi) to maintain color neutrality of the RME device.

To switch from the dissolution phase 210 to the deposition phase 212, pulsed electrodeposition is used by applying pulsed voltage to the RME device. The applied pulsed voltage includes an “on” state, where voltage is applied, and an “off” state, where voltage is not applied. The frequency and duty cycle can be defined using the following equations:

$$\begin{matrix}Frequency = \frac{1}{{t}_{o n} + {t}_{off}} \\ Duty cycle = \frac{{t}_{o n}}{{t}_{o n} + {t}_{off}}\end{matrix}$$

where tₒₙ is the time the pulse is in the on state and t_{off} is the time the pulse is in the off state.

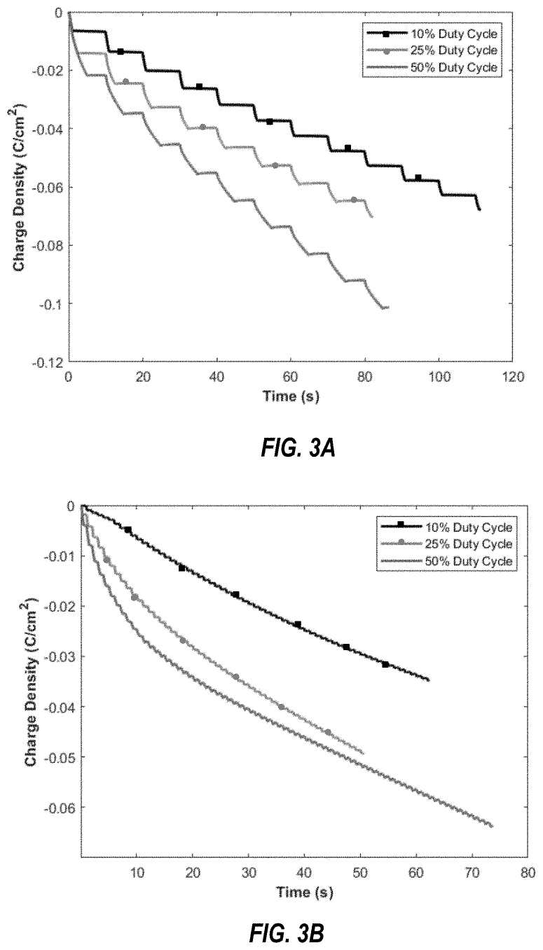

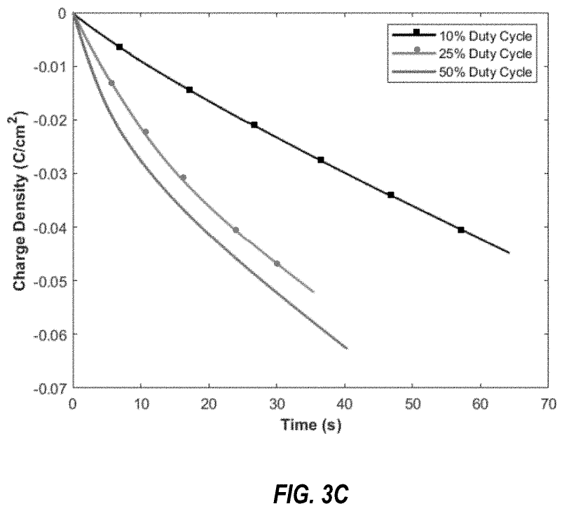

FIGS. 3 through 10 illustrate characterization of various experimental results of disclosed embodiments. Experiments compared applying pulsing voltage at three duty cycles (10%, 25%, and 50%) and three frequencies (0.1, 1, and 10 Hz). A particularly desirable duty cycle was found at 10% with a frequency of 1 Hz which allowed the double layer to charge and discharge and the concentration profile near the electrode surface to be restored. The time of the “on” and “off” state for each frequency and duty cycle combination is shown in Table 1.

TABLE 1

| Fre- | | Duty Cycle | | |
|---|---|---|---|---|
| quency | | 10% | 25% | 50% |
| 0.1 | Hz | 1 second “on” | 2.5 seconds “on” | 5 seconds “on” |
| | | 9 seconds “off' | 7.5 seconds “off” | 5 seconds “off” |
| 1 | Hz | 0.1 seconds “on” | 0.25 seconds “on” | 0.5 seconds “on” |
| | | 0.9 seconds “off” | 0.75 seconds “off” | 0.5 seconds “off” |
| 10 | Hz | 0.01 seconds “on” | 0.025 seconds “on” | 0.05 seconds “on” |
| | | 0.09 seconds “off” | 0.075 seconds “off” | 0.05 seconds “off” |

FIGS. 3A through 3C illustrate the total deposition time to achieve a reduction in transmission to a value of 10% transmission and the associated charge density using applied pulsed voltage as described in disclosed embodiments at 10%, 25%, and 50% duty cycles. FIG. 3A shows results at 0.1 Hz frequency. FIG. 3B shows results at 1 Hz frequency. FIG. 3C shows results at 10 Hz frequency. The deposition time and charge density to reach 10% transmission at each duty cycle and frequency is shown in Table 2.

TABLE 2

Duty Cycle

| | | | |
|---|---|---|---|
| Frequency | 10% | 25% | 50% |

| | | | | |
|---|---|---|---|---|
| 0.1 | Hz | 111.4 seconds | 81.9 seconds | 86.3 seconds |
| | | 0.068 C/cm² | 0.070 C/cm² | 0.101 C/cm² |
| 1 | Hz | 62.4 seconds | 50.8 seconds | 73.5 seconds |
| | | 0.035 C/cm² | 0.049 C/cm² | 0.064 C/cm² |
| 10 | Hz | 64.202 seconds | 35.41 seconds | 50.4 seconds |
| | | 0.045 C/cm² | 0.052 C/cm² | 0.063 C/cm² |

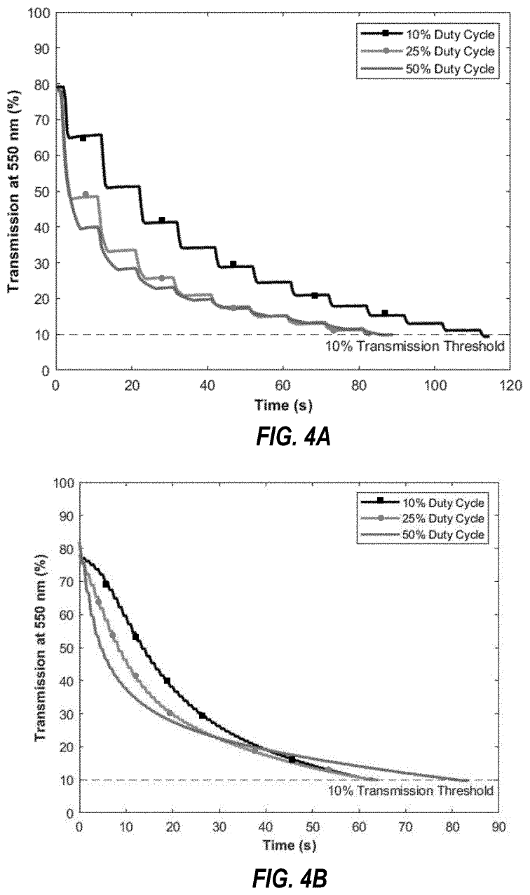

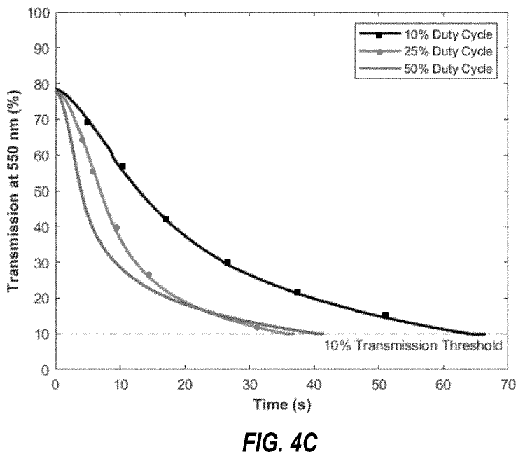

FIGS. 4A through 4C illustrate transmission through the window at 550 nm measured over time at duty cycles of 10%, 25% and 50%. FIG. 4A shows results at 0.1 Hz frequency. FIG. 4B shows results at 1 Hz frequency. FIG. 4C shows results at 10 Hz frequency.

FIGS. 3A through 4C and Table 1 illustrate that disclosed embodiments utilizing applied pulsed voltage result in smooth surfaces. The smooth surfaces are due to the fact that the “off” state of the applied pulsed voltage allows the concentration of metals in the diffusion layer near the electrode surface to recover which allows more ions to more uniformly deposit on the surface.

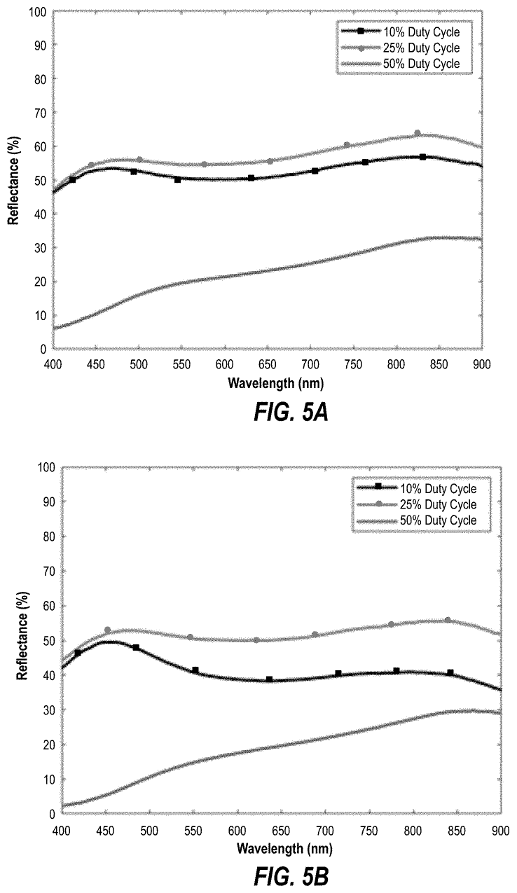

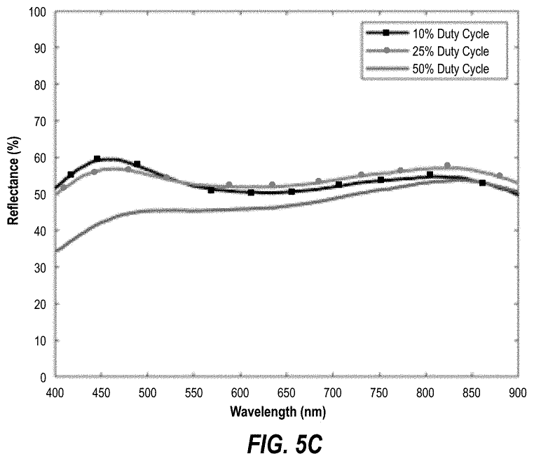

FIGS. 5A through 5C illustrate reflectance of disclosed embodiments tinted to 10% transmission for wavelengths from 400 nm to 900 nm measured over time at duty cycles of 10%, 25% and 50%. FIG. 5A shows results at 0.1 Hz frequency. FIG. 5B shows results at 1 Hz frequency. FIG. 5C shows results at 10 Hz frequency. The smooth surface created by the disclosed embodiments results in relatively higher reflectance values. For example, at 550 nm, a reflectance value of about 55% was observed at a frequency of 10 Hz, with a 10% or 25% duty cycle.

Table 3 shows the haze from 400 nm to 750 nm of disclosed embodiments tinted to 10% transmission at various frequencies and duty cycles. Haze was calculated by dividing the diffuse by total transmission at each wavelength and taking the average over the wavelength at two locations.

TABLE 3

Duty Cycle

| | | | |
|---|---|---|---|
| Frequency | 10% | 25% | 50% |

| | | | | |
|---|---|---|---|---|
| 0.1 | Hz | 1.92 | 1.45 | 2.10 |
| 1 | Hz | 2.05 | 2.28 | 2.06 |
| 10 | Hz | 2.88 | 2.27 | 3.18 |

Table 4 shows the color neutrality of disclosed embodiments tinted to 10% transmission at various duty cycles and frequencies. The color neutrality was determined by calculating chroma from values describing the brightness layer, the color on the red-green axis, and color on the blue-yellow axis. For a value of less than 10, the color of the material falls within the perception of grayscale for a human and is considered color neutral.

TABLE 4

Duty Cycle

| | | | |
|---|---|---|---|
| Frequency | 10% | 25% | 50% |

| | | | | |
|---|---|---|---|---|
| 0.1 | Hz | 8.1 | 6.2 | 7.9 |
| 1 | Hz | 7.9 | 7.4 | 7.1 |
| 10 | Hz | 7.8 | 7.6 | 7.9 |

Table 5 shows the coloration efficiency of disclosed embodiments tinted at 10% transmission at different duty cycles and frequencies. Coloration efficiency is calculated using the transmission at the start and end of the deposition cycle and charge densities. The coloration efficiency is related to how much energy is required to tint the disclosed embodiments. The coloration efficiency is maximized for low duty cycles.

TABLE 5

Duty Cycle

| | | | |
|---|---|---|---|
| Frequency | 10% | 25% | 50% |

| | | | | |
|---|---|---|---|---|
| 0.1 | Hz | 13.68 | 12.81 | 8.87 |
| 1 | Hz | 25.40 | 18.13 | 14.46 |
| 10 | Hz | 9.83 | 17.10 | 14.29 |

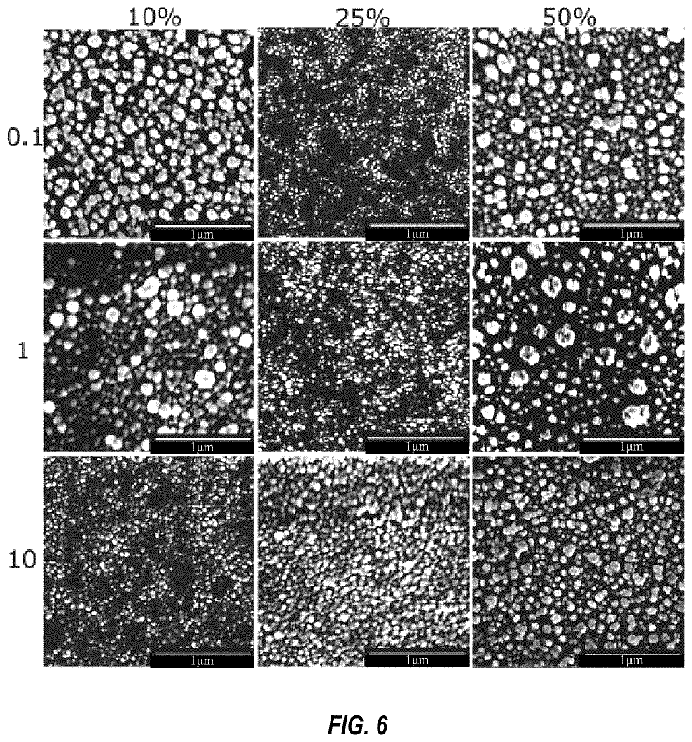

FIG. 6 shows SEM images of disclosed embodiments tinted to 10% transmission at various duty cycles and frequencies. In more detail, FIG. 6 illustrates how disclosed embodiments vary in surface morphology. For example, at 0.1 Hz and a 10% duty cycle, the deposits are fairly uniform in diameter but vary in height with a variance of 100 nm from peak to trough. At a frequency of 10 Hz with a 10% duty cycle, the deposits are smaller and generally uniform in diameter but the height variation is 14 nm from peak to trough. As duty cycle increases, the deposit diameters vary more than at lower duty cycles.

Table 6 shows the root mean squared (RMS) roughness measured in nanometers for disclosed embodiments tinted to 10% transmission at various duty cycles and frequencies. At a frequency of 0.1 Hz and a duty cycle of 10%, the RMS roughness is 13.70 nm while at a frequency of 10 Hz and a duty cycle of 10% the RMS roughness is 2.45 nm. As duty cycle increases, deposit diameters vary more than in lower duty cycles.

TABLE 6

Duty Cycle

| | | | |
|---|---|---|---|
| Frequency | 10% | 25% | 50% |

| | | | | |
|---|---|---|---|---|
| 0.1 | Hz | 13.70 | 13.03 | 22.46 |
| 1 | Hz | 7.44 | 7.62 | 12.71 |
| 10 | Hz | 2.45 | 7.95 | 6.00 |

Table 7 shows calculated diffusion distance measured in millimeters for disclosed embodiments at various frequencies and duty cycles. The diffusion distance is proportional to the “on” state and inversely proportional to the square root of the frequency. Thinner layers at higher frequencies require less distance for the ions to travel from the bulk concentration which reduces effects of irregularities on the surface. Therefore, the metal cations are able to diffuse between the initial deposits and plate uniformly and smoothly on the surface.

TABLE 7

Duty Cycle

| | | | |
|---|---|---|---|
| Frequency | 10% | 25% | 50% |

| | | | | |
|---|---|---|---|---|
| 0.1 | Hz | 0.125 | 0.198 | 0.280 |
| 1 | Hz | 0.040 | 0.063 | 0.089 |
| 10 | Hz | 0.013 | 0.020 | 0.028 |

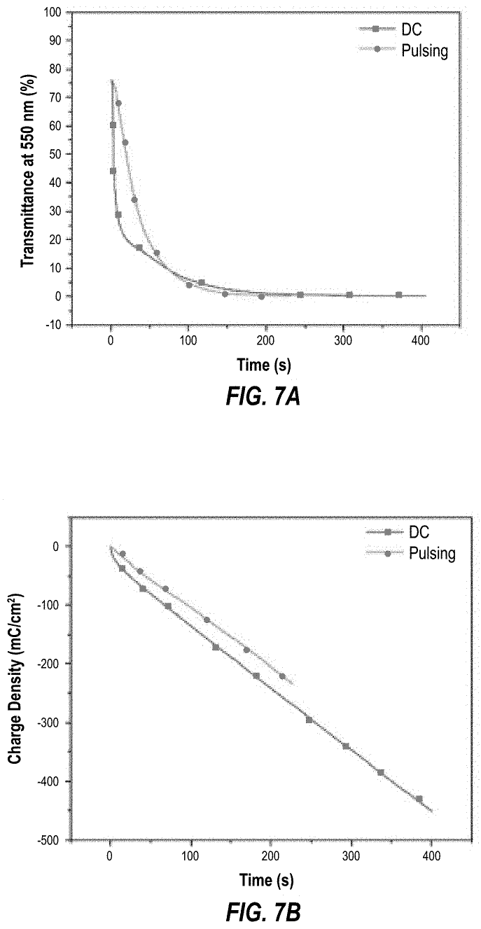

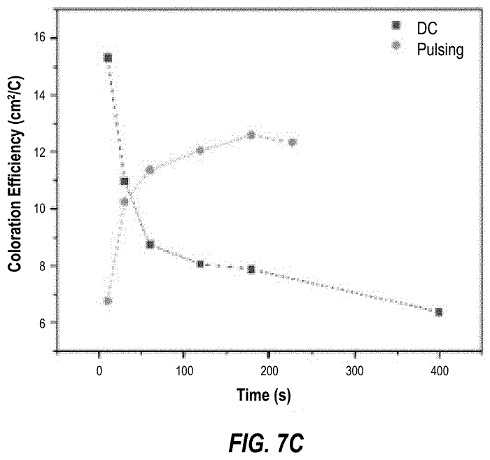

FIGS. 7A through 7C illustrate spectro-electrochemical results which compare disclosed embodiments using pulsed voltage to conventional DC voltage. In more detail, FIG. 7A illustrates transmittance at 550 nm over time. As shown in FIG. 7A, disclosed embodiments tint slower at first, however, disclosed embodiments achieve a transmittance of 0.1% faster than conventional DC applied voltage. FIG. 7B illustrates charge density over time of disclosed embodiments using pulsed voltage compared to conventional applied DC voltage. Disclosed embodiments also achieve a transmittance of 0.1% with less charge than conventional DC applied voltage.

FIG. 7C illustrates coloration efficiency over time. Color efficiency describes how efficiently the electroplated film blocks light and combines the change in optical density and associated charged density passed. Similarly to FIGS. 7A and 7B, initially, the conventional DC applied voltage had a higher coloration efficiency. However, for times over about 60 seconds, disclosed embodiments with applied pulsed voltage show higher coloration efficiency.

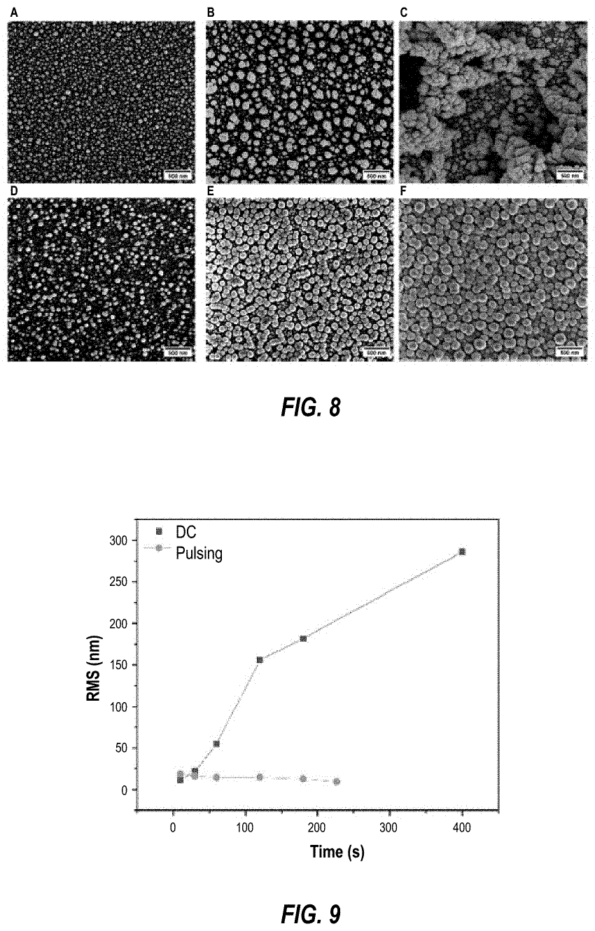

FIG. 8 illustrates SEM images of metal films created by applied pulsed voltage described by disclosed embodiments and conventional DC applied voltage. The top row shows the metal film created by DC applied voltage after 10 seconds (left), 120 seconds (middle), and when 0.1% transmittance state is achieved (right). The bottom row shows the metal film created by applied pulsed voltage as described in disclosed embodiments after 10 pulses (left), after 120 pulses (middle) and when 0.1% transmittance state is achieved (right).

Similar to FIGS. 7A through 7C, initially the conventional DC applied current results in faster tint states. However, as time goes on for the conventional DC applied current, the diffusion length for the metal ions in solution grows which results in growth of metal pillars shown in FIG. 8 (top row, middle). The metal pillars, or dendritic film, is less effective at blocking light and requires more metal and charge to achieve a given light transmission reduction. In contrast, disclosed embodiments using applied pulsed voltage result in a consistent diffusion length, as shown in FIG. 8 (bottom row, middle), due to the fact that the ion concentration replenishes during the “off” state. As a result, the metal ions are able to diffuse to the electrode surface creating a more uniform film which is more efficient in blocking light.

FIG. 9 illustrates the root mean square (RMS) roughness values obtained with AFM measurements. Conventional DC applied voltage results in RMS values of up to 285 nm while disclosed embodiments using applied pulsed voltage stay below 20 nm. As a result, the thickness of the metal film to achieve 0.1% transmittance is significantly smaller in the disclosed pulsed embodiments than when using DC applied voltage.

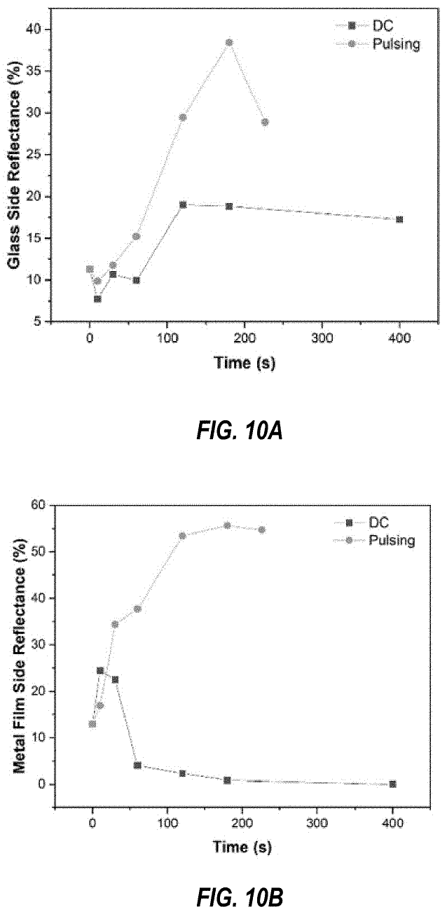

FIGS. 10A and 10B illustrate reflectance at 550 nm at various tinting times of metal films created using applied pulsed voltage as described in disclosed embodiments and conventional DC applied voltage. FIG. 10A illustrates reflectance from the glass side of the RME device and FIG. 10B illustrates reflectance from the metal film side of the RME device. In general, disclosed embodiments have larger reflectance values than conventional DC applied voltage metal film. In more detail, FIG. 10B illustrates that the DC applied voltage metal film increases in reflectance initially then drops to nearly 0% as the metal film becomes rougher and contains more dendrites. The DC applied voltage metal film scatters more light and results in the film becoming more absorptive. Metal films from disclosed embodiments using applied pulsed voltage result in reflectance increasing during tinting up to about 54% then remaining steady. The metal film from applied pulsed voltage results in a consistent and smooth film throughout the plating resulting in a more effective reflecting and heat rejecting material.

While pulsing ultimately results in faster tinting to a very low transmittance (e.g., 0.1%) privacy state, DC plating is faster in the initial stages of tinting, as shown in the Figures. As such, in an embodiment, to achieve the fastest tinting speed, the tinting protocol may include a DC plating step before pulsing. For example, in an embodiment, the DC plating time may be 5 seconds to 30 seconds, or about 10 seconds. Limiting the DC plating time ensures that the DC deposited film has not yet achieved a high surface roughness, and by switching to pulsing, the concentration profile can still adequately be restored. By way of example, such a combination tinting protocol (DC for about 10 seconds, followed by pulsing to the desired final transmittance) can reduces the total tinting time significantly (e.g., by 50-60% as compared to use of DC only, or by about 20-25% as compared to pulsing only, when tinting to a 0.1% privacy state transmittance. Such a reduction in tinting time makes such windows substantially more attractive to users. In addition, the reduction in how much metal is deposited and the avoidance of dendrites achieved with pulsing will greatly improve cycle life of such windows.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Ranges between any values disclosed herein are contemplated, and within the scope of the present disclosure.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “electrode”) may also include two or more such referents.

It will also be appreciated that embodiments described herein may also include properties and/or features (e.g., components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A method comprising:
providing a reversible metal electrodeposition (RME) device comprising:
two transparent substrates, wherein each transparent substrate is on an outside of the device;
a working electrode located near one of the two transparent substrates;
a counter electrode located near another of the two transparent substrates; and
an electrolyte solution located between the working electrode and the counter electrode;
applying a pulsed voltage to the RME device, wherein the pulsed voltage includes an on phase and an off phase;
causing electrochemical deposition of metal ions from the electrolyte solution, creating a metallic film on the working electrode; and
reducing light transmittance, by the metallic film, of the RME device.

2. The method of claim 1, wherein the electrolyte solution includes water and at least one of Cu(ClO₄), BiOClO₄, HClO₄, or LiClO₄.

3. The method of claim 1, wherein the working electrode is a transparent conducting oxide (TCO) working electrode.

4. The method of claim 3, wherein the working electrode is a Pt modified ITO working electrode.

5. The method of claim 1, wherein the metal ions include Cu and Bi.

6. The method of claim 1, wherein the pulsed voltage has a duty cycle of about 5%, or about 10%, or about 15%, or about 20%, or about 25%, or about 50%, or about 60%, or from about 5% to about 60%.

7. The method of claim 1, wherein the pulsed voltage has a frequency of about 0.1 Hz, or about 0.5 Hz, or about 1 Hz, or about 5 Hz, or about 10 Hz, or about 15 Hz, or about 20 Hz, or from about 0.1 Hz to about 20 Hz.

8. The method of claim 1, wherein reducing light transmittance results in about 0.1% transmittance, or about 1% transmittance, or about 5% transmittance, or about 10% transmittance, or about 15% transmittance or from about 0.1% transmittance to about 15% transmittance.

9. The method of claim 1, wherein the pulsed voltage is applied for about 0.1 second, or about 1 second, or about 10 seconds, or about 20 seconds, or about 30 seconds, or about 60 seconds, or about 120 seconds, or from about 0.1 second to about 120 seconds.

10. The method of claim 1, wherein the RME device is color neutral, with a chroma value of less than 10.

11. The method of claim 1, wherein a user controls an amount of light transmittance that is reduced.

12. The method of claim 1, wherein reducing light transmittance is reversible.

13. The method of claim 1, wherein the RME device is a window.

14. A reversible metal electrodeposition (RME) device, comprising:
two transparent substrates, wherein each transparent substrate is on an outside of the device;
a working electrode located near one of the two transparent substrates;
a counter electrode located near another of the two transparent substrates; and
an electrolyte solution located between the working electrode and the counter electrode,
a power source that delivers a pulsed voltage to the working electrode and/or the counter electrode;
wherein the RME device reversibly changes light transmittance when the pulsed voltage is applied to the RME device which causes electrochemical deposition of metal ions from the electrolyte solution to create a metallic film on the working electrode.

15. The RME device of claim 14, wherein the RME device is color neutral with a chroma value of less than 10.

16. The RME device of claim 14, wherein the RME device is a window.

17. The RME device of claim 14, wherein the electrolyte solution includes water and at least one of Cu(ClO₄), BiOClO₄, HClO₄, or LiClO₄.

18. The RME device of claim 14, wherein the working electrode is a transparent conducting oxide (TCO) working electrode.

19. The RME device of claim 18, wherein the working electrode is a Pt modified ITO working electrode.

20. The RME device of claim 14, wherein the metal ions include Cu and Bi.
